(19) United States
(12) Patent Application Publication
(10) Pub. No.: US 2025/0266738 A1
(43) Pub. Date: Aug. 21, 2025

(54) ACTUATOR

(71) Applicant: Minebea Mitsumi Inc., Nagano (JP)

(72) Inventors: Frank HIESTAND, Villingen-Schwenningen (DE); Fabian SEKINGER, Eschbronn-Mariazell (DE)

(21) Appl. No.: 19/053,652

(22) Filed: Feb. 14, 2025

(30) Foreign Application Priority Data
Feb. 20, 2024 (DE) 102024104637.6

(51) Int. Cl. H02K 7/116; H02K 5/22; H02K 11/215

(52) U.S. Cl. CPC H02K 7/116; H02K 5/22; H02K 11/215

(57) ABSTRACT

An actuating drive including a housing, which comprises a housing trough and a housing cover, an electric motor arranged in the housing, a gear unit arranged in the housing that has an output gear, and a position detection unit arranged in the housing for detecting a rotational angle position of the output gear, which detection unit comprises a magnet arranged on a rotary axle of the output gear, and a magnetic field sensor unit having a magnetic field sensor designed to detect a magnetic field of the magnet. It is proposed that he housing trough of the housing has a receiving region in which the magnetic field sensor unit is arranged such that the rotary axle of the output gear extends through the magnetic field sensor of the magnetic field sensor unit.

### FIELD

The invention relates to an actuating drive.

### BACKGROUND

DE 10 2020 108 860 A1 already discloses an actuating drive having a housing comprising a housing trough and a housing cover. The housing of the actuating drive contains an electric motor, a spur gear with an output gear and a position detection unit for detecting the rotational angle position of the output gear. The position detection unit comprises a magnet arranged on a rotary axle of the output gear and a magnetic field sensor configured to detect a magnetic field of the magnet. The magnetic field sensor of the position detection unit is arranged on a rigid circuit board together with actuating drive control electronics. In order to arrange the magnetic field sensor in the rotary axle of the output gear, the circuit board has a complex geometry. In addition, the arrangement of the magnetic field sensor on the one rigid circuit board makes it difficult to accurately position the magnetic field sensor in the rotary axle of the output gear.

A corresponding actuating drive is also already known from DE 10 2020 120 241.

This disclosure provides an actuating drive, which has advantageous properties, in particular with regard to positioning the magnetic field sensor in the rotary axle of the output gear, and/or a compact design.

### SUMMARY

This disclosure provides an actuating drive having a housing, which comprises a housing trough and a housing cover, an electric motor arranged in the housing, a gear unit arranged in the housing that comprises an output gear, and a position detection unit arranged in the housing for detecting a rotational angle position of the output gear, which unit comprises a magnet arranged on a rotary axle of the output gear, and a magnetic field sensor unit comprising a magnetic field sensor designed to detect a magnetic field of the magnet.

It is proposed that the housing trough of the housing has a receiving region in which the magnetic field sensor unit is arranged such that the rotary axle of the output gear extends through the magnetic field sensor of the magnetic field sensor unit.

The actuating drive can be used in particular in the automotive sector and/or in automation technology, for example as a flap actuating drive and/or valve actuating drive, for example for needle valves.

The housing of the actuating drive is designed in particular as a two-part housing. The housing comprises a housing trough and a housing cover, which is fixed to the housing trough when the actuating drive is mounted and at least largely seals the trough against dirt and/or liquid. Preferably, both the housing trough and the housing cover are made of plastics. In particular, the housing trough and the housing cover are injection-molded plastics parts. The housing cover can be connected to the housing trough, for example, by gluing, screwing or, preferably, by laser welding. The electric motor of the actuating drive arranged in the housing trough is designed in particular as a brushless DC motor. The electric motor is designed in particular as an internal rotor motor, which comprises a stator and a rotor rotatably arranged within the stator. The rotor has a pinion which transmits a rotary motion of the rotor to a gear unit of the actuating drive which is also arranged in the housing trough.

The gear unit is designed in particular as a multi-stage spur gear, wherein an output gear forms the last gear wheel of the gear unit. The gear unit is preferably designed as a reduction gear. The output gear is mechanically coupled to the pinion of the rotor of the electric motor via the further gear wheels of the gear unit so that a rotary motion of the rotor of the electric motor causes a rotary motion of the output gear via the further gear wheels of the gear unit. The output gear is in particular designed to be mechanically coupled to an actuator, for example to cause the actuator to move as a result of a rotary motion of the output gear. The output gear has in particular an output shaft with a suitable driving profile, wherein the output shaft can in particular be designed as a hollow shaft and the driving profile can in particular be arranged on an inner and/or outer circumference of the output shaft. The housing cover comprises a circular recess via which an end of the output shaft that comprises the driving profile is guided out of the housing of the actuating drive or via which an end of the output shaft that comprises the driving profile is accessible for connection to an actuator to be driven by means of the actuating drive. The end of the output shaft that comprises the driving profile is rotatably mounted in the recess in the housing cover, in particular by means of a plain bearing. In addition, a shaft sealing ring is arranged in the recess in the housing cover and is designed to seal the housing of the actuating drive at the output shaft guided out thereof.

In addition to the electric motor and the gear unit comprising the output gear, a position detection unit is also arranged in the housing trough and is designed to detect a rotational angle position of the output gear during operation of the actuating drive. The position detection unit comprises a magnet arranged on a rotary axle of the output gear. The magnet is arranged on a side of the output gear facing toward the bottom of the housing trough of the actuating drive. In particular, the magnet is fastened to the side of the output gear facing the bottom of the housing trough for conjoint rotation therewith and is arranged on a rotary axle of the output gear. The rotary axle of the output gear extends through a body of the magnet. The rotary axle runs through the magnet body itself, i.e., not through an opening in the magnet body, as is the case with ring-shaped position magnets, for example. In particular, the output gear has a receptacle for the magnet extending toward the bottom of the housing trough. In particular, the magnet is fixed in the receptacle of the output gear by means of a form fit, a force fit and/or an integral bond. The magnet is preferably magnetized in a plane that is perpendicular to the rotary axle of the output gear. The magnet can, for example, be a two-pole magnet having a north pole and a south pole or a multi-pole magnet having more than two poles, e.g., a quadrupole magnet. When the output gear rotates, the magnet moves together with the output gear, which changes the magnetic field generated by the magnet. This change can be detected by means of a magnetic field sensor of the position detection unit, which sensor is arranged in the rotary axle of the output gear such that it cannot move relative to the magnet, and the rotational angle position of the gear wheel can be determined therefrom.

The magnetic field sensor is in particular designed to detect the strength and/or direction of a magnetic field of the magnet of the position detection unit arranged on the output gear. The magnetic field sensor can be, for example, an inductive magnetic field sensor or a Hall-effect sensor, e.g., a one-dimensional, two-dimensional or three-dimensional Hall-effect sensor, which is designed to measure the strength of the magnetic field in one, two or three spatial directions, respectively. If the output gear is moved, the magnetic field changes at the location of the magnetic field sensor. The rotational angle position of the output gear can thus be determined using the magnetic field measured. To actuate the electric motor, the measured values recorded by the magnetic field sensor are transmitted to a control unit that is also arranged within the housing trough and is designed to actuate the electric motor on the basis of these measured values or to determine the rotational angle position of the output gear on the basis of these measured values in order to allow precise actuation of the electric motor. The magnetic field sensor unit is immovably arranged on the bottom of the housing trough of the actuating drive housing. In particular, the magnetic field sensor unit can be rigidly connected to the bottom of the housing trough in order to at least largely prevent the magnetic field sensor unit from moving. The housing trough has at its bottom a receiving region, which is delimited in particular by a circumferential wall, within which the magnetic field sensor unit is arranged such that the rotary axle of the output gear extends through the magnetic field sensor of the magnetic field sensor unit. The circumferential wall can be designed in particular to at least largely eliminate any axial play of the output gear.

By means of such a configuration, it is possible to provide an actuating drive of the type in question having advantageous properties, in particular with regard to positioning the magnetic field sensor of the magnetic field sensor unit relative to the magnet of the position detection unit. In particular, by arranging and fixing the magnetic field sensor unit on a bottom of the housing trough, the magnetic field sensor is immovably positioned relative to the magnet arranged on the output gear. Positioning can also be simplified and/or improved by providing a dedicated receiving region in the housing trough for the arrangement of the magnetic field sensor unit.

It is further proposed that the receiving region is delimited by an annular wall which extends from a bottom of the housing trough and into an interior of the housing and runs concentrically around the rotary axle of the output gear. This makes it possible to achieve precise positioning of the magnetic sensor of the magnetic field sensor unit in relation to the magnet of the magnetic field sensor unit that is arranged on the output gear. The circular wall is integrally formed in particular on the bottom of the housing trough. Preferably, the circular wall is produced during manufacture of the housing trough. This can easily be done by manufacturing the housing trough using plastics injection molding. The circular wall extends from the bottom of the housing trough toward the output gear. The wall encloses the receiving region in the circumferential direction, resulting in a circular base surface for the receiving region. Since the wall runs concentrically around the rotary axle of the output gear, the rotary axle runs vertically through the center of the receiving region. When mounted, the magnetic field sensor unit is arranged in the receiving region such that the magnetic field sensor of the magnetic field sensor unit is located in the center of the receiving region, and therefore the rotary axle of the output gear passes through the magnetic field sensor. In particular, additional alignment elements, such as pins, can be arranged in the receiving region and can make it even easier to precisely position the magnetic field sensor unit. The circular wall of the receiving region can also be used to mount the output gear. For this purpose, the output gear protrudes into the receiving region enclosed by the circular wall, the circular wall forming a plain bearing the output gear.

It is also proposed that the magnetic field sensor unit comprises a circular rigid circuit board in the center of which the magnetic field sensor is arranged. The circular rigid circuit board allows simple, in particular fully automatic, fitting of the magnetic field sensor. In addition, the circular rigid circuit board allows for precise positioning of the magnetic field sensor unit in the receiving region of the housing trough. The circular rigid circuit board is preferably made of FR4 material. The magnetic field sensor is arranged in particular in the center of the circular circuit board. In particular, the circuit board can have at least two circular through-recesses. The through-recesses are in particular designed to interact with an equal number of alignment elements of the receiving region of the housing trough. At least two cylindrical pins can in particular be arranged in the receiving region of the housing trough as alignment elements, which are designed to be inserted into the circular through-recesses in the circular rigid circuit board when the circular rigid circuit board is inserted into the receiving region of the housing trough. Due to the interaction between the at least two cylindrical pins of the receiving region of the housing trough and the at least two through-recesses in the circular rigid circuit board of the magnetic field sensor unit, the magnetic field sensor unit can be accurately positioned within the receiving region of the housing trough, it thus being possible for the magnetic field sensor of the magnetic field sensor unit to be precisely arranged in the rotary axle of the output gear. It is also conceivable that an outer circumference of the circuit board of the magnetic field sensor unit rests against an inner circumference of the wall of the receiving region when the magnetic field sensor unit is mounted, as a result of which the circular rigid circuit board of the magnetic field sensor unit can also be accurately oriented in the receiving region of the housing trough. Preferably, the circular rigid circuit board of the magnetic field sensor unit is fixed in the receiving region of the housing trough by means of at least one heat-staking connection on the bottom of the housing trough. This can allow the circular rigid circuit board of the magnetic field sensor unit to be reliably and/or simply fixed in the receiving region of the housing trough. In particular, this fixing can be done via at least two alignment elements of the receiving region of the housing trough, which are designed as cylindrical pins and which pass through at least two corresponding through-recesses in the circular rigid circuit board of the magnetic field sensor unit arranged in the receiving region of the housing trough. For this purpose, free ends of the cylindrical pins protruding from the through-recesses in the circular rigid circuit board of the magnetic field sensor unit are thermally deformed in such a way that mushroom heads are formed that interlockingly fix the circular rigid circuit board of the magnetic field unit at least in the axial direction.

Furthermore, it is proposed that the actuating drive comprises a control unit which comprises a rigid circuit board arranged in the housing trough above the electric motor when viewed from the bottom of the housing trough. The control unit comprises in particular control electronics for actuating the electric motor, in particular also on the basis of measured values recorded by the magnetic field sensor unit and transmitted to the control unit. The control unit comprises a rigid circuit board on which the control electronics are arranged and which is in particular placed directly on the electric motor, as a result of which stator coils of the electric motor can be directly connected to the rigid circuit board of the control unit. To transmit the measured values from the magnetic field sensor unit to the control unit, the control unit is connected to the magnetic field sensor unit via a plurality of electrical lines. Preferably, the actuating drive comprises a flexible circuit board which electrically connects the rigid circuit board of the control unit to the circular rigid circuit board of the magnetic field sensor unit. This allows the electrical connection between the control unit and the magnetic field sensor unit to be flexible with minimum space requirements. In particular, a height difference between the rigid circuit board of the control unit and the circular rigid circuit board of the magnetic field sensor unit can also be easily bridged. In order to bridge the height difference, the flexible circuit board is preferably guided from the rigid circuit board of the control unit to the bottom of the housing trough and along the bottom of the housing trough to the circular rigid circuit board of the magnetic field sensor unit. The flexible circuit board is formed in particular from a carrier film, for example a polyimide film, to which a plurality of conductor tracks, in particular copper conductor tracks, is applied. The conductor tracks of the flexible circuit board are electrically conductively connected to both the rigid circuit board of the control unit and the circular rigid circuit board of the magnetic field sensor unit.

In an example, it is proposed that the rigid circuit board of the control unit, the circular rigid circuit board of the magnetic field sensor unit and the flexible circuit board are integrally formed as a rigid-flex circuit board. Rigid-flex circuit boards are hybrids that consist of a combination of at least one conventional rigid circuit board and at least one flexible circuit board. In particular, rigid-flex circuit boards can consist of a plurality of rigid parts that are seamlessly connected to one another by means of a flexible circuit board. Rigid-flex circuit boards therefore form a mechanical and electrical unit. By using a rigid-flex circuit board, polarity and/or contact reliability can be achieved with regard to the electrical conductivity between the control unit and the magnetic field sensor unit. In addition, plug and/or line components can be eliminated.

In addition, it is proposed that the flexible circuit board is fixed in a region between the rigid circuit board of the control unit and the circular rigid circuit board of the magnetic field sensor unit by means of at least one heat-staking connection on the bottom of the housing trough. This allows the flexible circuit board to be fixed in position in the housing trough. In particular, at least one tab is formed on the carrier film of the flexible circuit board, which has a through-recess. Preferably, a plurality of tabs is formed on the carrier film of the flexible circuit board, each tab having a through-recess. In particular, formed on the bottom of the housing trough is a number of cylindrical pins that corresponds to the number of tabs of the carrier film of the flexible circuit board, which pins are designed to extend through the through-recesses in the tabs of the flexible circuit board arranged on the bottom of the housing trough. Mushroom heads are formed by thermal deformation of the free ends of the cylindrical pins, which mushroom heads fix the flexible circuit board in a form-fitting manner to the bottom of the housing trough, at least in the axial direction.

The output gear can be directly slidingly and rotatably mounted by means of the circular wall, which limits the receiving region of the housing trough. Alternatively, however, it is conceivable that the actuating drive has an annular plain bearing element for mounting the output gear such that it rotates about the rotary axle, which gear is arranged in the receiving region of the housing trough. The plain bearing element can in particular consist of a plastics material with good sliding properties. The plain bearing element has in particular an outer diameter which substantially corresponds to an inner diameter of the circular wall of the receiving region of the housing trough such that the plain bearing element rests in an assembled state with its outer circumference on the inner circumference of the circular wall of the receiving region of the housing trough, at least substantially without any play. In particular, the circular wall of the receiving region of the housing trough can have a step on which the sliding bearing element rests in an assembled state such that the sliding bearing element is axially spaced apart from the bottom of the housing trough and the circular rigid circuit board of the magnetic field sensor unit arranged on the bottom of the housing trough in the receiving region.

The actuating drive is not intended to be limited to the application and examples described above. In particular, the actuating drive can have a number of individual elements, components and units that differs from the number mentioned herein in order to fulfill a function described herein.

### BRIEF DESCRIPTION OF THE DRAWINGS

Further advantages can be found in the following description of the drawings. The drawings show an example of the actuating drive of this disclosure. The drawings, the description and the claims contain numerous features in combination. Those skilled in the art will also expediently consider the features on their own and combine them into further meaningful combinations.

In the drawings:

FIG. 1 is an exploded view of an actuating drive;

FIG. 2 is a sectional view of the actuating drive in FIG. 1

FIG. 3 is a perspective plan view of the actuating drive from FIG. 1 shown without the housing cover and gear unit; and

FIG. 4 is a sectional view of an output gear of the actuating drive from FIG. 1.

### DETAILED DESCRIPTION

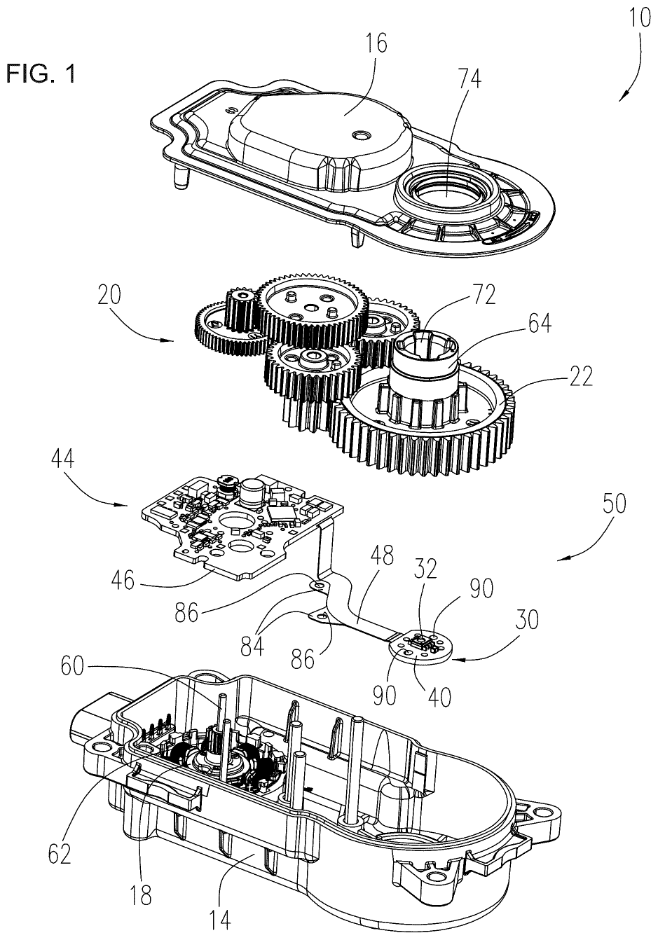

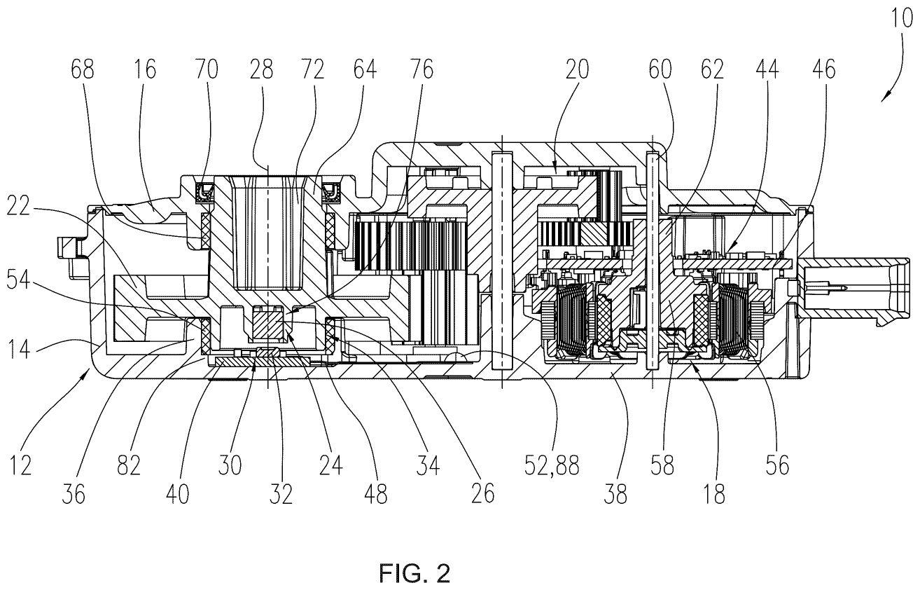

FIG. 1 is an exploded view of an actuating drive 10. FIG. 2 shows the actuating drive 10 in a sectional view. The actuating drive 10 has a two-part housing 12, which comprises a housing trough 14 and a housing cover 16. The housing trough 14 and the housing cover 16 of the housing 12 are preferably designed as injection molded plastics parts. In an assembled state of the actuating drive 10, the housing trough 14 is closed by means of the housing cover 16. In particular, the housing cover 12 can be glued or welded to the housing trough 14.

The actuating drive 10 further comprises an electric motor 18, which is arranged in the housing trough 14 of the housing 12. The electric motor 18 is preferably designed as a brushless DC motor. The actuating drive 10 has a control unit 44 with a rigid circuit board 46. In particular, control electronics for actuating the electric motor 18 are arranged on the rigid circuit board 46 of the control unit 44. The rigid circuit board 46 of the control unit is placed directly on the electric motor 18. Viewed from a bottom 38 of the housing trough 14 of the housing 12, the rigid circuit board 46 of the control unit 44 is arranged above the electric motor 18.

The electric motor 18 comprises a stator 56 and a rotor 58 that is rotatably mounted within the stator 56. The rotor 58 is rotatably mounted on a stationary axle 60 and rotates about this stationary axle 60 during operation of the electric motor 18. The rotor 58 has a pinion 62 which is designed to transmit a rotary motion of the rotor 58 to a gear unit 20 of the actuating drive 10. The gear unit 20 of the actuating drive 10, as well as the electric motor 18, is arranged in the housing trough 14 of the housing 12. The gear unit 20 is designed as a multi-stage spur gear with a plurality of gear wheels, wherein an output gear 22 forms the last gear wheel of the gear unit 20. The output gear 22 is coupled to the pinion 62 of the rotor 58 of the electric motor 18 via the other gear wheels of the gear unit so that a rotary motion of the rotor 58 is transmitted to the output gear 22 via the gear wheels arranged between the pinion 62 and the output gear 22.

The output gear 22 is designed to be mechanically coupled to an actuator (not shown here), for example to transform a rotary motion of the output gear 22 into a movement of the actuator. The output gear 22 comprises an output shaft 64 designed as a hollow shaft, which has a driving profile 72 for mechanically coupling to an actuator to be driven. The housing cover 16 has a circular recess 74 in which the output shaft 64 of the output gear 22 is mounted so as to rotate about a rotary axle 28 by means of a plain bearing 68. In the recess 74 in the housing cover 16, there is also arranged a shaft sealing ring 70, which is designed to seal the housing 12 of the actuating drive 10 at the output shaft 64 of the output gear 22 guided out thereof.

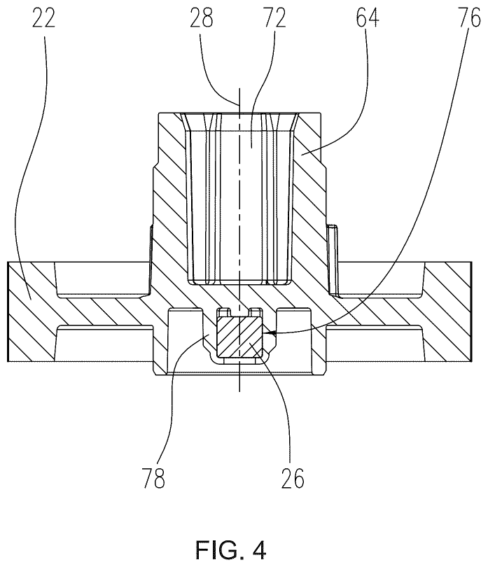

To detect a rotational angle position of the output gear 22, the actuating drive 10 comprises a position detection unit 24, which is also arranged in the housing trough 14 of the housing 12. The position detection unit 24 has a magnet 26 which is arranged on the rotary axle 28 of the output gear 22. The magnet 26 is arranged on a side of the output gear 22 facing the direction of the bottom 38 of the housing trough 14 of the housing 12. In order to arrange the magnet 26 in the rotary axle 28 of the output gear 22, the output gear 22 has a receptacle 76 for the magnet 26 that extends in the direction of the bottom 38 of the housing trough 14 of the housing 12. The magnet 26 is arranged within the receptacle 76 of the output gear 22 for conjoint rotation. The magnet 26 can in particular be fixed in the receptacle 76 of the output gear 22 by means of a form fit, force fit and/or integral bond. For example, the magnet 26 can be pressed into and/or glued in the receptacle 76. Alternatively, however, it is also conceivable that the magnet 26 is fixed in the receptacle, as shown in FIG. 4, by the deformation, in particular thermal deformation, of a wall 78 of the receptacle 76. The magnet 26 is arranged in the receptacle 76 such that the rotary axle 28 of the output gear 22 extends through a body of the magnet 26. The magnet 26 is preferably magnetized in a plane perpendicular to the rotary axle 28 of the output gear 22. The magnet 26 can, for example, be a two-pole magnet with a north pole and a south pole or a multi-pole magnet with more than two poles, e.g., a quadrupole magnet.

In addition to the magnet 26, the position detection unit 24 has a magnetic field sensor unit 30 with a magnetic field sensor 32. The magnetic field sensor 32 of the magnetic field sensor unit 30 is configured to detect a magnetic field of the magnet 26. The housing trough 14 of the housing 12 has a receiving region 34 in which the magnetic field sensor unit 30 is arranged such that the rotary axle 28 of the output gear 22 extends through the magnetic field sensor 32 of the magnetic field sensor unit 30. When the output gear 22 rotates, the magnet 26 also rotates relative to the magnetic field sensor 32 of the magnetic field sensor unit 30. This changes the magnetic field at the location of the magnetic field sensor 32 of the magnetic field sensor unit 30. The rotational angle position of the output gear 22 can be determined using the measured magnetic field.

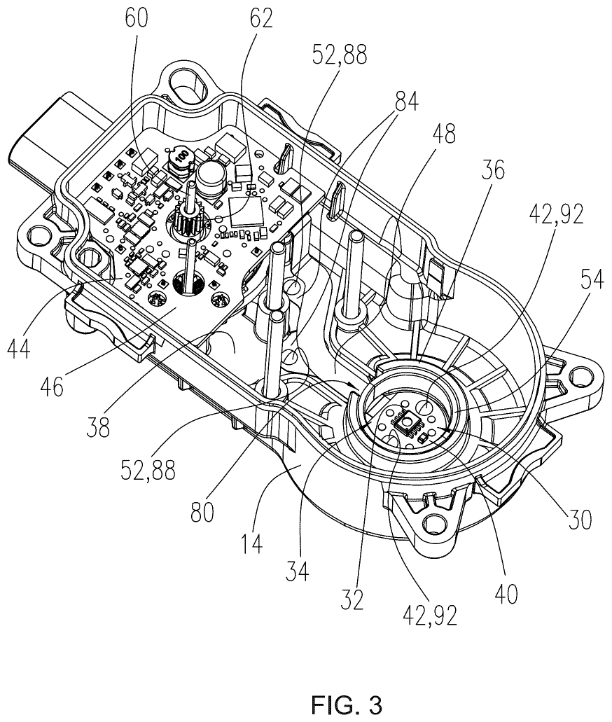

The receiving region 34 for receiving the magnetic field sensor unit 30 is delimited by an annular wall 36. The wall of the receiving region 34 extends from the bottom 38 of the housing trough 14 of the housing 12 into an interior of the housing 12 and thus in the direction of the output gear 22. The wall 34 of the receiving region 34 runs concentrically about the rotary axle 28 of the output gear 22. The receiving region 34 thus has a circular base surface, wherein the rotary axle 28 of the output gear 22 runs perpendicularly through the center of the circular base surface of the receiving region 34 (cf. FIG. 3).

The magnetic field sensor unit 30 has a circular, rigid circuit board 40 in the middle of which the magnetic field sensor 32 is arranged. The circular rigid circuit board 40 of the magnetic field sensor unit 30 is arranged in the receiving region 34 such that the magnetic field sensor 32 is located at the center of the circular base surface of the receiving region 34. The magnetic field sensor 32 of the magnetic field sensor unit 30 is arranged such that the rotary axle 28 of the output gear 22 extends through the magnetic field sensor 32 of the magnetic field sensor unit 30. The circular, rigid circuit board 40 of the magnetic field sensor unit 30 is fixed in the receiving region 34 of the housing trough 14 by means of two heat-staking connections 42 on the bottom 38 of the housing trough 14 of the housing 12. To produce the heat-staking connections 42, the circular, rigid circuit board 40 of the magnetic field sensor unit 30 has two through-recesses 90. Two cylindrical pins (not shown here) are formed on the bottom 38 of the housing trough 14 in the receiving region 34 and are designed to extend through the through-recesses 90 in the circular rigid circuit board 40 of the magnetic field sensor unit 30 arranged on the bottom 38 of the housing trough 14. Through thermal deformation of free ends of the cylindrical pins, mushroom heads 92 are formed which fix the circular rigid circuit board 40 of the magnetic field sensor unit 30 in the receiving region 34 on the bottom 38 of the housing trough 14 (cf. FIG. 3).

To connect the circular rigid circuit board 40 of the magnetic field sensor unit 30 to the rigid circuit board 46 of the control unit 44, the actuating drive 10 has a flexible circuit board 48. The flexible circuit board 48 consists in particular of a carrier film to which a plurality of conductor tracks is applied. In order to bridge the height difference between the rigid circuit board 46 of the control unit 44 and the circular rigid circuit board 40 of the magnetic field sensor unit 30, the flexible circuit board 48 is guided from the rigid circuit board 46 of the control unit to the bottom 38 of the housing trough 14 and along the bottom 38 of the housing trough 14 of the housing 12 to the circular rigid circuit board 40 of the magnetic field sensor unit 30 (cf. FIG. 3). Here, the flexible circuit board 48 is deflected twice, each time at an angle of at least substantially 90°. In order to guide the flexible circuit board 48 along the bottom 38 of the housing trough 14 of the housing 12 into the receiving region 34 for the magnetic field sensor unit 30, the circular wall 36 of the receiving region 34 has a recess 80 facing the direction of the electric motor 18, through which recess the flexible circuit board 48 is guided. Preferably, the rigid circuit board 46 of the control unit 44, the circular rigid circuit board 40 of the magnetic field sensor unit 30 and the flexible circuit board 48 are integrally formed as a rigid-flex circuit board 50. In this case, in particular, the use of additional plug connectors can be dispensed with in order to electrically connect the flexible circuit board 48 to the rigid circuit board 46 of the control unit 44 and the circular rigid circuit board 40 of the magnetic field sensor unit 30. In a region between the rigid circuit board 46 of the control unit 44 and the circular rigid circuit board 40 of the magnetic field sensor unit 30, the flexible circuit board 48 is fixed to the bottom 38 of the housing trough 14 by means of two heat-staking connections 52. To produce the heat-staking connections 52, the flexible circuit board 48 has two tabs 84, with a through-recess 86 formed in each tab 84. Two cylindrical pins (not shown here) are formed on the bottom 38 of the housing trough 14 and are designed to extend through the through-recesses 86 in the tabs 84 of the flexible circuit board 48 arranged on the bottom 38 of the housing trough 14. By thermal deformation of free ends of the cylindrical pins, mushroom heads 88 are formed which fix the flexible circuit board 48 to the bottom 38 of the housing trough 14 (cf. FIG. 3).

In order to also mount the output gear 22 on a side opposite the output shaft 64 so that it can rotate about the rotary axle 28, the actuating drive 10 has an annular plain bearing element 54 which is arranged in the receiving region 34 of the housing trough 14. The sliding bearing element 54 is preferably made of a plastics material with good sliding properties. An outer diameter of the plain bearing element 54 corresponds at least substantially to an inner diameter of the circular wall 36 of the receiving region 34 of the housing trough 14. In an assembled state, the outer circumference of the plain bearing element 54 rests against the inner circumference of the circular wall of the receiving region 34 of the housing trough 14. The circular wall 36 of the receiving region 34 of the housing trough 14 has a step 82 on which the sliding bearing element 54 rests in an assembled state such that the sliding bearing element 54 is arranged axially spaced apart from the bottom 38 of the housing trough 14. This allows the flexible circuit board 48 to be guided under the plain bearing element 54 into the receiving region 34 of the housing trough 14.

List of reference numerals

| | |
|---|---|
| 10 | actuating drive |
| 12 | housing |
| 14 | housing trough |
| 16 | housing cover |
| 18 | electric motor |
| 20 | gear unit |
| 22 | output gear |
| 24 | position detection unit |
| 26 | magnet |
| 28 | rotary axle |
| 30 | magnetic field sensor unit |
| 32 | magnetic field sensor |
| 34 | receiving region |
| 36 | receiving region wall |
| 38 | bottom |
| 40 | circular circuit board |
| 42 | heat-staking connection |
| 44 | control unit |
| 46 | circuit board control unit |
| 48 | flexible circuit board |
| 50 | rigid-flex circuit board |
| 52 | heat-staking connection |
| 54 | plain bearing element |
| 56 | stator |
| 58 | rotor |
| 60 | axle |
| 62 | pinion |
| 64 | output shaft |
| 68 | plain bearing |
| 70 | shaft sealing ring |
| 72 | driving profile |
| 74 | cover recess |
| 76 | receptacle |
| 78 | receptacle wall |
| 80 | recess |
| 82 | step |
| 84 | tab |
| 86 | through-recess |
| 88 | mushroom head |
| 90 | through-recess |
| 92 | mushroom head |

What is claimed is:

1. An actuating drive comprising a housing, which comprises a housing trough and a housing cover, an electric motor arranged in the housing, a gear unit arranged in the housing that has an output gear and a position detection unit arranged in the housing for detecting a rotational angle position of the output gear, which detection unit comprises a magnet arranged on a rotary axle of the output gear and a magnetic field sensor unit having a magnetic field sensor which is designed to detect a magnetic field of the magnet, wherein the housing trough of the housing has a receiving region in which the magnetic field sensor unit is arranged such that the rotary axle of the output gear extends through the magnetic field sensor of the magnetic field sensor unit.

2. The actuating drive according to claim 1, wherein the receiving region is delimited by an annular wall which extends from the bottom of the housing trough and into the interior of the housing and runs concentrically around the rotary axle of the output gear.

3. The actuating drive according to claim 1, wherein the magnetic field sensor unit comprises a circular, rigid circuit board in the center of which the magnetic field sensor is arranged.

4. The actuating drive according to claim 3, wherein the circular rigid circuit board of the magnetic field sensor unit is fixed in the receiving region of the housing trough by means of at least one heat-staking connection on the bottom of the housing trough.

5. The actuating drive according to claim 3, further comprising a control unit which comprises a rigid circuit board which is arranged in the housing trough above the electric motor when viewed from the bottom of the housing trough.

6. The actuating drive according to claim 5, further comprising a flexible circuit board which electrically connects the rigid circuit board of the control unit to the circular rigid circuit board of the magnetic field sensor unit.

7. The actuating drive according to claim 6, wherein the flexible circuit board is guided from the rigid circuit board of the control unit to the bottom of the housing trough and along the bottom of the housing trough to the circular rigid circuit board of the magnetic field sensor unit.

8. The actuating drive according to claim 6, wherein the rigid circuit board of the control unit, the circular rigid circuit board of the magnetic field sensor unit and the flexible circuit board are integrally formed as a rigid-flex circuit board.

9. The actuating drive according to claim 6, wherein the flexible circuit board is fixed in position in a region between the rigid circuit board of the control unit and the circular rigid circuit board of the magnetic field sensor unit by means of at least one heat-staking connection on the bottom of the housing trough.

10. The actuating drive according to claim 1, further comprising an annular plain bearing element for mounting the output gear such that it can rotate about the rotary axle, which bearing element is arranged in the receiving region of the housing trough.
